(19) United States
(12) Patent Application Publication
(10) Pub. No.: US 2008/0033866 A1
(43) Pub. Date: Feb. 7, 2008

(54) System and a method for facilitating a lease on a domain name through an online competitive bidding process

(75) Inventors: Jonathan J. Boswell, Van Nuys, CA (US); Ammar Kubba, Sherman Oaks, CA (US); Kevin P. Vo, Malibu, CA (US)

Correspondence Address: MCDERMOTT WILL & EMERY LLP, 18191 VON KARMAN AVE., SUITE 500, IRVINE, CA, 92612-7108, US

(73) Assignee: LEASE THIS, LLC, Los Angeles, CA (US)

(21) Appl. No.: 11/807,078

(22) Filed: May 24, 2007

Related U.S. Application Data
(60) Provisional application No. 60/808,115, filed on May 25, 2006.

(51) Int. Cl. G06Q 40/00

(52) U.S. Cl. 705/37

(57) ABSTRACT

A system and a method is provided for facilitating a lease on a domain name through an online competitive bidding process. Domain name owners can offer their domain names for a lease utilizing the present invention, and the bidders can search and bid for desired premium domain names. The winning bidder acquires the lease to the domain name which includes at least the right to use the Internet traffic to the leased domain name and direct the traffic to a web site or any other Internet resource or media location designated by the lessee. The lease to a domain name according to the present invention can include the right of the lessee such that the lease remains in effect during the term of the lease even if the ownership of the domain name is transferred to another party. For the winning bidder, the lease to the domain name affords the same benefits and advantages of owning the domain name outright for the duration of the lease term. However, the lessee needs to pay only a fraction of the price of owning the domain name outright. For the premium domain name owners, the present invention provides access to a much larger market for their valuable asset and ability to generate steady income much more efficiently. The result is a much more efficient and effective utilization of valuable domain name assets than the existing methods of buying and selling the domain name outright.

### CROSS-REFERENCE TO RELATED APPLICATION

The present application claims the benefit of priority under 35 U.S.C. § 119 from U.S. Provisional Patent Application Ser. No. 60/808,115 entitled “SYSTEM AND A METHOD FOR FACILITATING A LEASE ON A DOMAIN NAME THROUGH AN ONLINE COMPETITIVE BIDDING PROCESS,” filed on May 25, 2006, the disclosure of which is hereby incorporated by reference in its entirety for all purposes.

### STATEMENT REGARDING FEDERALLY SPONSORED RESEARCH OR DEVELOPMENT

Not applicable

### FIELD OF THE INVENTION

The present invention relates to a system and a method for leasing domain names, and, in particular, a system and a method for facilitating a lease on a domain name through an online competitive bidding process.

### BACKGROUND OF THE INVENTION

The growth of popularity of the Internet is largely due to the World Wide Web. The Web is a collection of interconnected documents linked together through hyperlinks over the Internet. Through the Internet, Web users are able to access a vast amount of worldwide documents, known as web pages, which exist on host computers known as web servers. Each host computer on the Internet has a unique identifier called an IP address so that a computer and data on the computer such as a web page can be located and accessed over the Internet.

An IP address is a 32 bit number, and, as such, most people find it difficult to remember or recall the IP address for the computer they want to access. To solve this problem, the Domain Name System (DNS) is utilized to map or substitute an IP address with a unique text string (or alphanumeric string) known as the domain name. For example, it is much easier to remember “computers.com” than the corresponding IP address number.

However, the Domain Name System is not without problems. As a domain name can only resolve to one host computer, each domain name must be unique and may be registered by only one registrant. Because there are a finite number of terms for common services, goods, or subject matters and there is a multitude of people who wish to use these terms, the current Domain Name System breeds intense competition over the so-called premium domain names with easily recognizable or highly descriptive names. This scarcity of premium domain names created a market for domain names where the most desired premium domain names may be valued at an excess of one million dollars which may be beyond the reach of many business entities.

It can be seen, then, that there is a need in the field of Internet commerce for an approach that can provide more effective access to premium domain names without incurring the high cost of owning the domain name.

### SUMMARY OF THE INVENTION

Accordingly, the present invention addresses the foregoing need by providing a system and a method for facilitating a lease on a domain name through an online competitive bidding process.

Domain name owners can offer their domain names for a lease utilizing the present invention, and the bidders can search and bid for desired premium domain names. The winning bidder acquires the lease to the domain name which includes at least the right to use the Internet traffic to the leased domain name and direct the traffic to a web site or any other Internet resource or media location designated by the lessee. The lease to a domain name according to the present invention can include the right of the lessee such that the lease remains in effect during the term of the lease even if the ownership of the domain name is transferred to another party. For the winning bidder, the lease to the domain name affords the same benefits and advantages of owning the domain name outright for the duration of the lease term. However, the lessee needs to pay only a fraction of the price of owning the domain name outright. For the premium domain name owners, the present invention provides access to a much larger market for their valuable asset and ability to generate steady income much more efficiently. The result is a much more efficient and effective utilization of valuable domain name assets than the existing methods of buying and selling the domain name outright.

In one aspect of the invention, the present invention is a system for facilitating a lease on a domain name using a computer network through an online competitive bidding process including a computer system, programming code on the computer system for offering a domain name for lease through an online competitive bidding process in substantially real time, programming code on the computer system for allowing one or more bidders to enter bids for leasing the domain name and participate in the online competitive bidding process with a designated duration in substantially real time, wherein the bids include at least the bid price, programming code on the computer system for ranking the bids, wherein the ranking is based on at least the bid price, programming code on the computer system for determining which bidder is the winning bidder at the expiration of the designated duration of the bidding process, and programming code on the computer system for assigning the lease to the domain name to the winning bidder as a lessee.

According to another aspect of the invention, the present invention is a method for facilitating a lease on a domain name using a computer network through an online competitive bidding process including listing a domain name being offered for a lease, receiving bids for a lease on the domain name through an online competitive bidding process with a designated duration, wherein the bids include at least the bid price, ranking the received bids, wherein the ranking is based on at least the bid price, determining the winning bid with the highest ranking at the expiration of the designated duration of the bidding process, and assigning the lease to the domain name to the bidder of the winning bid as a lessee.

According to another aspect of the invention, the present invention is computer-executable process steps for facilitating a lease on a domain name using a computer network through an online competitive bidding process including a step for listing a domain name being offered for a lease, a step for receiving bids for a lease on the domain name through an online competitive bidding process with a designated duration, wherein the bids include at least the bid price, a step for ranking the received bids, wherein the ranking is based on at least the bid price, a step for determining the winning bid with the highest ranking at the expiration of the designated duration of the bidding process, a step for securing the lease on the domain name to the bidder of the winning bid with the winning bid amount as the lease price, a step for conveying the lease on the domain name to the bidder of the winning bid as the lessee to the domain name, a step for activating the lease on the domain name for the lessee, and a step for directing visitors to the leased domain name to an Internet resource location of the lessee's choice such as a Uniform Resource Locator (URL).

Other and further objects and advantages of the present invention will be further understood and appreciated by those skilled in the art by reference to the following specification, claims, and drawings.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 illustrates the operating environment of the present invention;

FIG. 2 illustrates a system for facilitating a lease on a domain name through an online competitive bidding process according to the present invention;

FIG. 3 illustrates the starting screen of the application for facilitating a lease on a domain name through an online competitive bidding process according to the present invention;

FIG. 4 illustrates the auctions screen of the application for facilitating a lease on a domain name through an online competitive bidding process according to the present invention;

FIG. 5 illustrates the bidding screen of the application for facilitating a lease on a domain name through an online competitive bidding process according to the present invention;

FIG. 6 illustrates another bidding screen of the application for facilitating a lease on a domain name through an online competitive bidding process according to the present invention;

FIG. 7 illustrates the bidding confirmation screen of the application for facilitating a lease on a domain name through an online competitive bidding process according to the present invention;

FIG. 8 illustrates the bidding completion screen of the application for facilitating a lease on a domain name through an online competitive bidding process according to the present invention;

FIG. 9 is a flowchart illustrating a method for facilitating a lease on a domain name through an online competitive bidding process according to the present invention;

FIG. 10 illustrates the campaign screen of the application for facilitating a lease on a domain name through an online competitive bidding process according to the present invention; and

FIG. 11 illustrates the leased domain name screen of the application for facilitating a lease on a domain name through an online competitive bidding process according to the present invention.

### DETAILED DESCRIPTION OF THE INVENTION

In the following detailed description, numerous specific details are set forth to provide a full understanding of the present invention. It will be apparent, however, to one ordinarily skilled in the art that the present invention may be practiced without some of these specific details. In other instances, well-known structures and techniques have not been shown in detail to avoid unnecessarily obscuring the present invention.

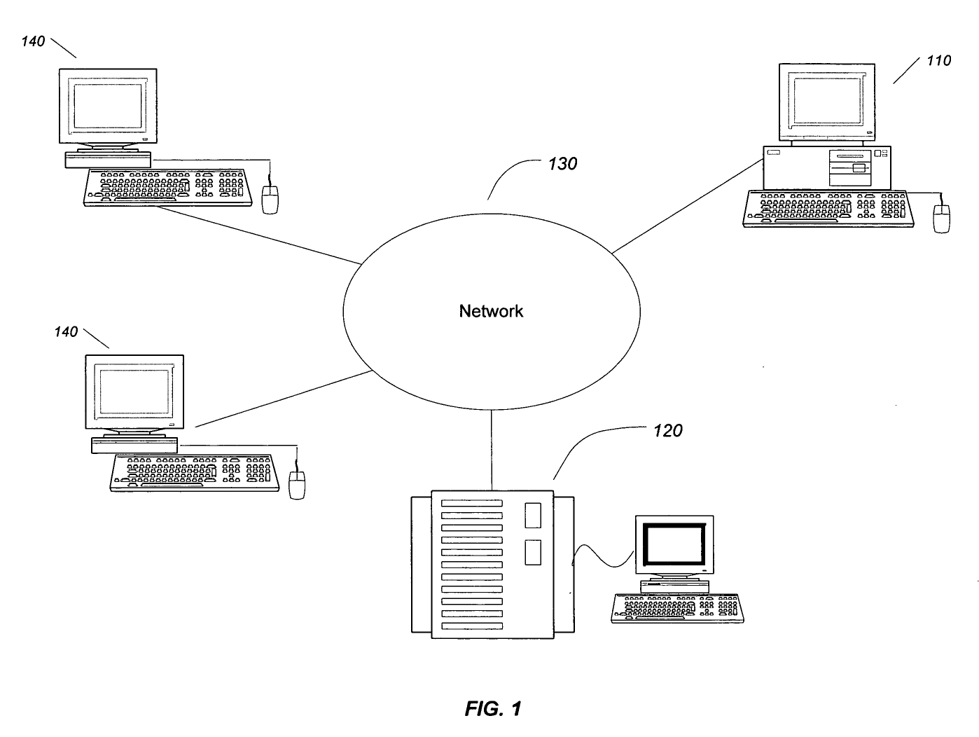

FIG. 1 illustrates the operating environment of the present invention. As shown in FIG. 1, leasing a domain name through an online competitive bidding process according to the present invention takes place in a computer network environment. For example, a domain name owner at a client computer 110 can access the domain name lease auction server 120 over a computer network 130 to offer a domain name to be leased through an online competitive bidding process. A bidder at a client workstation 140 may then bid for the lease on the offered domain name by accessing the domain name lease auction server 120 over a computer network 130.

A System for Facilitating a Lease on a Domain Name Through an Online Competitive Bidding Process

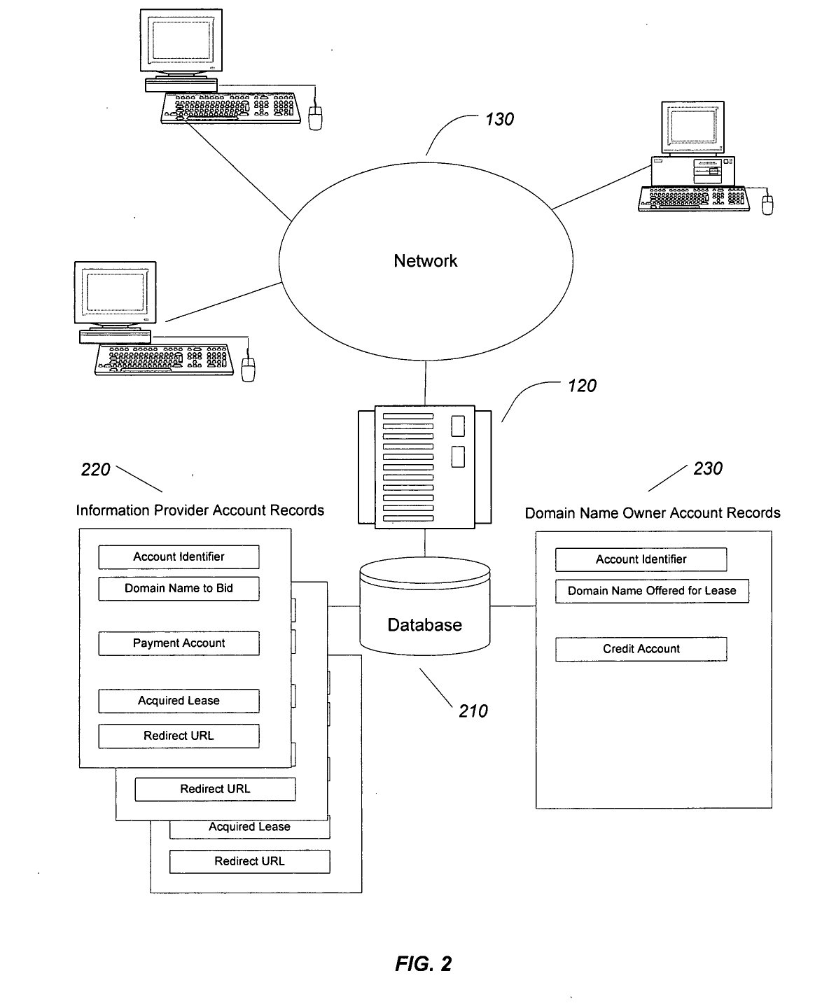

FIG. 2 illustrates a system for facilitating a lease on a domain name through an online competitive bidding process according to the present invention. As shown in FIG. 2, the system according to the present invention includes a facilitator server computer system 120 which hosts a domain name lease auction service. The domain name owners and bidders access the facilitator server 120 over the network 130 to participate in the online competitive bidding process to lease the domain names facilitated by the system of the present invention. The facilitator server 120 can be any server computer system known to those skilled in the art such as a Linux server, a Unix server, a Windows server, a server cluster, and a server farm without departing from the scope of the present invention. In a preferred embodiment, the facilitator server 120 is a scalable server computer system that is able to accommodate seamlessly exponentially increasing demands on the server which is characteristic of a popular Internet service or application. The network can be any combination of intranets and the Internet that can provide access between the client computers or workstations and the facilitator server 120.

As shown in FIG. 2, the facilitator server computer system 120 of the present invention includes a database 210 stored on the computer system 120. The database 210 according to the present invention includes bidder account records 220 and domain name owner account records 230. The bidder records 220 can include, for each bidder account, a unique account identifier, a payment account, the lease acquired if any, and the URL to which to direct the visitors to the leased domain name. The domain name owner records 230 can include, for each domain name owner account, a unique account identifier, domain names offered for lease, and the account to credit successful lease proceeds. The database 210 can be any database system known to those skilled in the art including the client-server based database systems such as Oracle, relational database systems, and object oriented database systems without departing from the scope of the present invention.

In a preferred embodiment, the system according to the present invention can also include a client-server application where the server application runs on the facilitator server computer system 120 and communicates with the client application running on a client workstation 140. The client-server application of the present invention can be a web application running over the Internet without departing from the scope of the present invention.

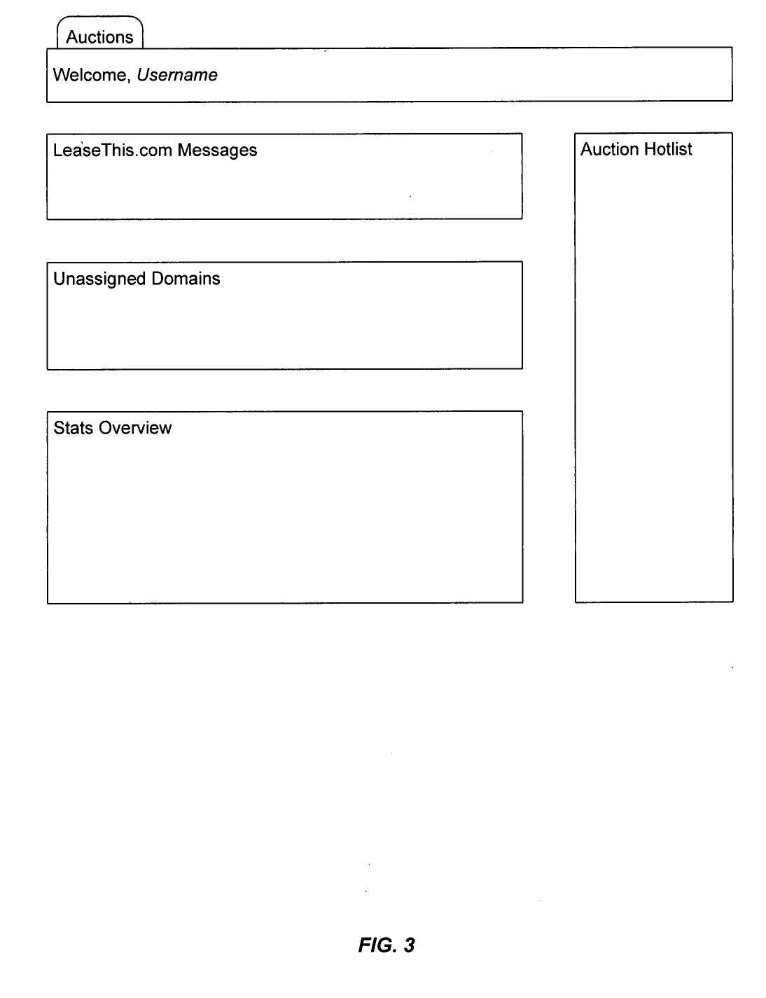

FIG. 3 illustrates the starting screen of the application for facilitating a lease on a domain name through an online competitive bidding process according to the present invention. Before the bidding process can take place, a domain name owner or a bidder establishes an account with the system of the present invention, and logs into the account using a computer network 130. When a domain name owner or bidder logs into its account, the application for facilitating a lease on a domain name would present the starting screen shown in FIG. 3. Preferably, the log-in process is performed by utilizing a secure authentication server.

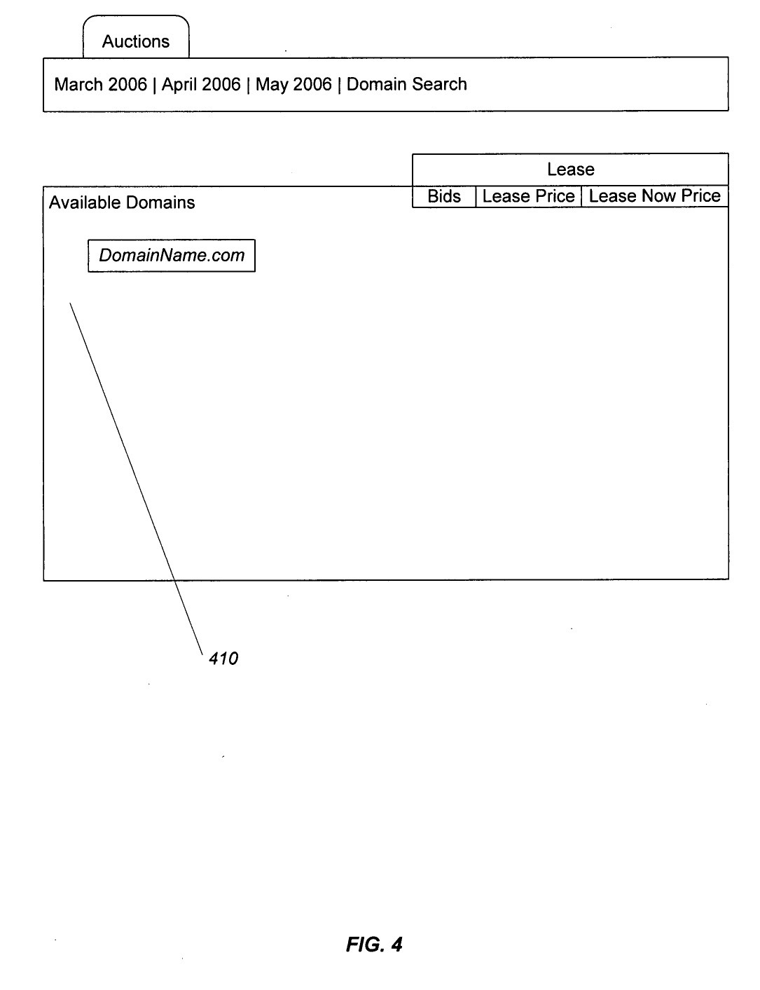

FIG. 4 illustrates the auctions screen of the application for facilitating a lease on a domain name through an online competitive bidding process according to the present invention. As shown in FIG. 4, domain names available for a lease are listed in the Available Domain Names screen area 410 which is updated in substantially real time as domain name owners offer their domain names for a lease.

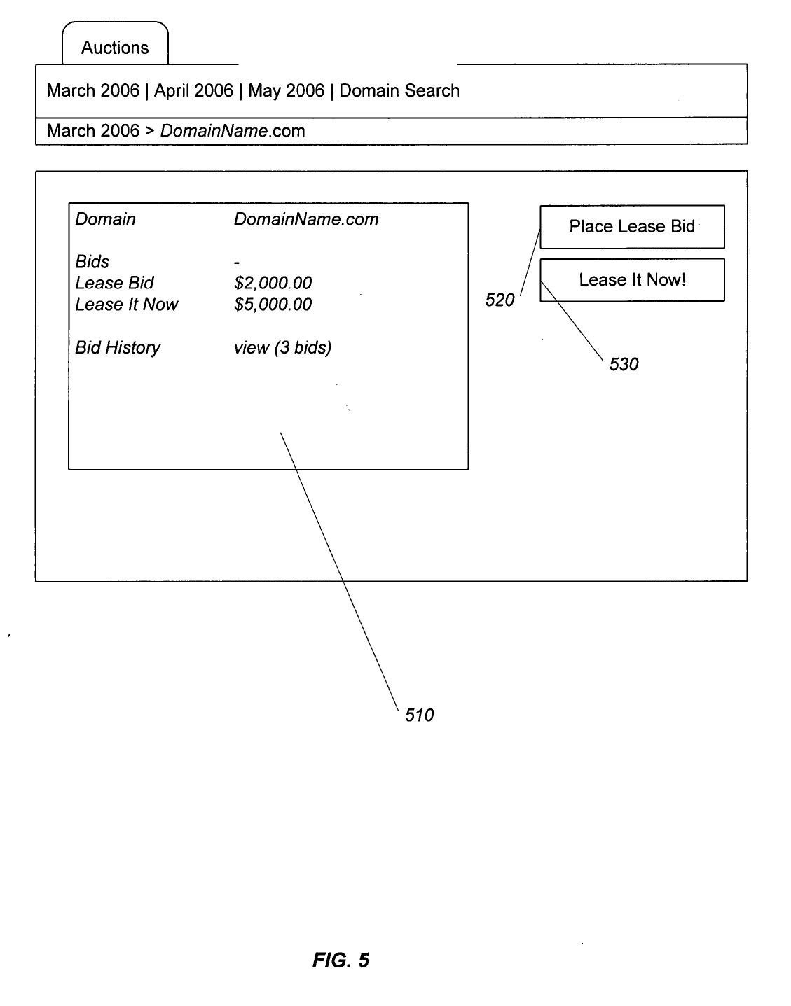

FIG. 5 illustrates the bidding screen of the application for facilitating a lease on a domain name through an online competitive bidding process according to the present invention. As shown in FIG. 5, the bidding screen includes the bidding information area 510 which displays the current bid amount, the number of current bids, and the “Lease It Now” price which is the price to lease the domain name outright. The bidding screen also includes the Place Bid button 520 and Lease It Now button 530. By clicking on the Lease It Now button 530, the bidder will proceed to a screen to confirm leasing the offered domain name outright at the “Lease It Now” price. By clicking on the Place Bid button 520, the bidder will proceed to the next screen in the bidding process.

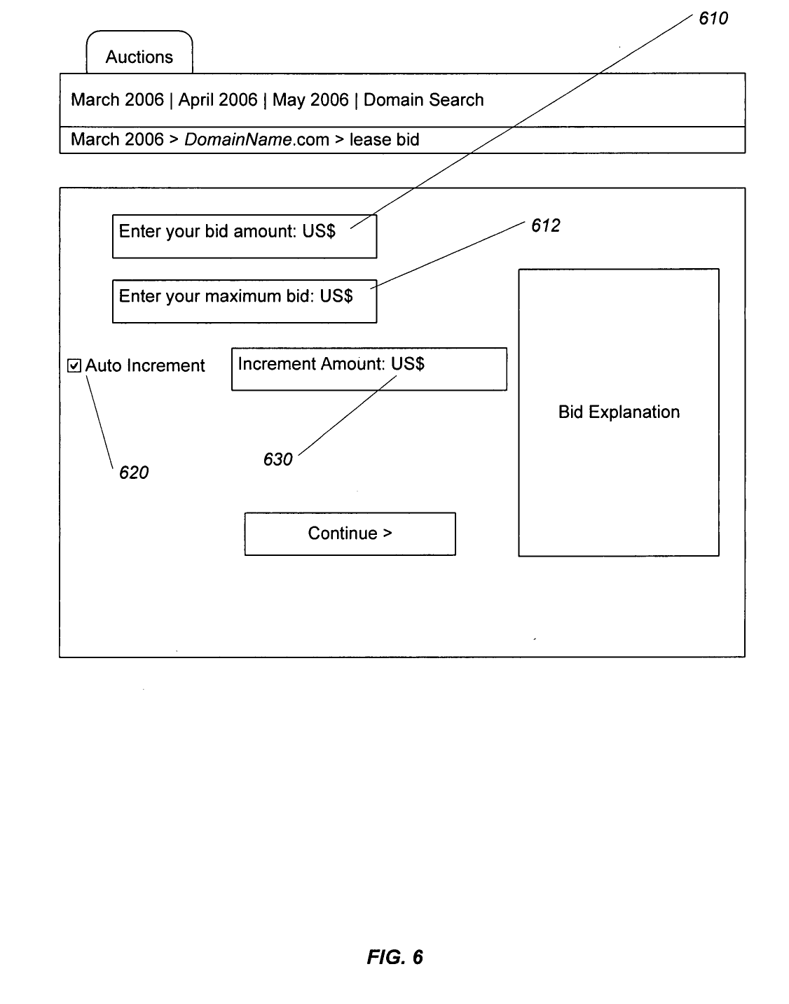

FIG. 6 illustrates another bidding screen of the application for facilitating a lease on a domain name through an online competitive bidding process according to the present invention. The system of the present invention receives the bids through the bidding screen shown in FIG. 6. For example, when the bidder to enter a bid amount in the Bid Amount Entry screen area 610, the system of the present invention receives a bid with a fixed bid price. In addition, the bidder can specify a maximum bid by entering the amount in the Maximum Bid Entry screen area 612. The bidder can also activate the automatic increment bidding process by checking the Auto Increment checkbox 620. The auto increment amount may be determined by the system of the present invention or specified by the bidder through the Increment Amount field 630.

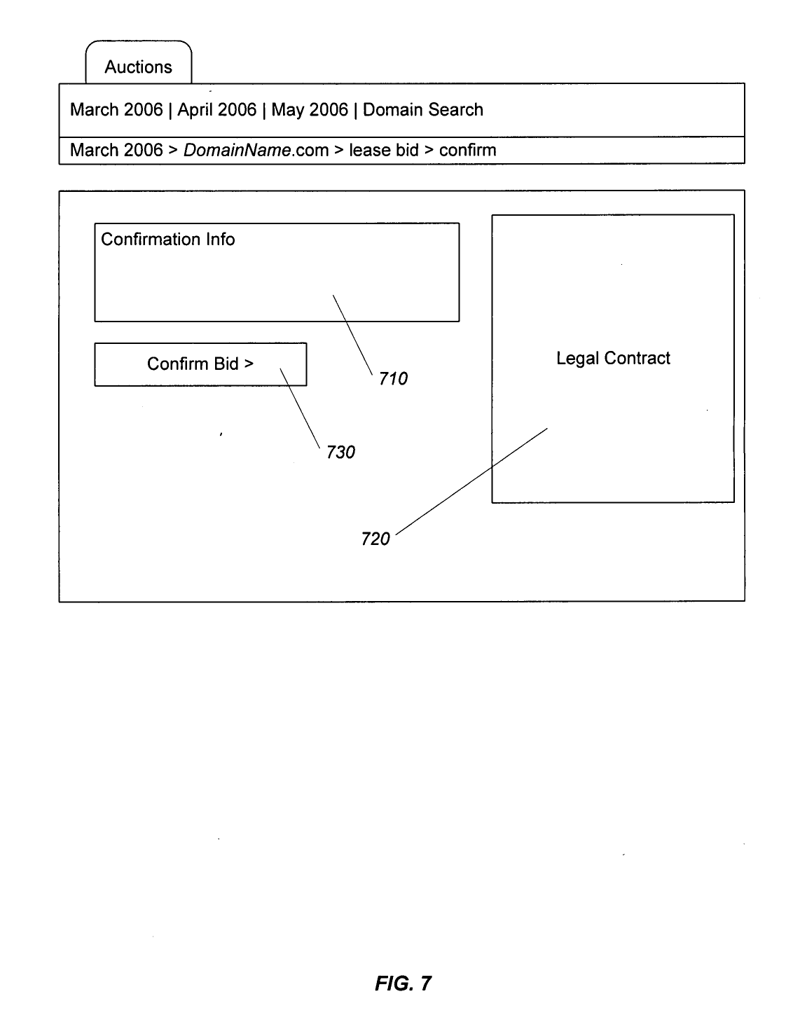

FIG. 7 illustrates the bidding confirmation screen of the application for facilitating a lease on a domain name through an online competitive bidding process according to the present invention. As shown in FIG. 7, the information on the bid to be placed is displayed in the Confirmation Info screen area 710. The text of terms of the legal contract is also displayed prominently in the Legal Contract screen area 720. The bidder confirms its bid by clicking on the Confirm Bid button 730.

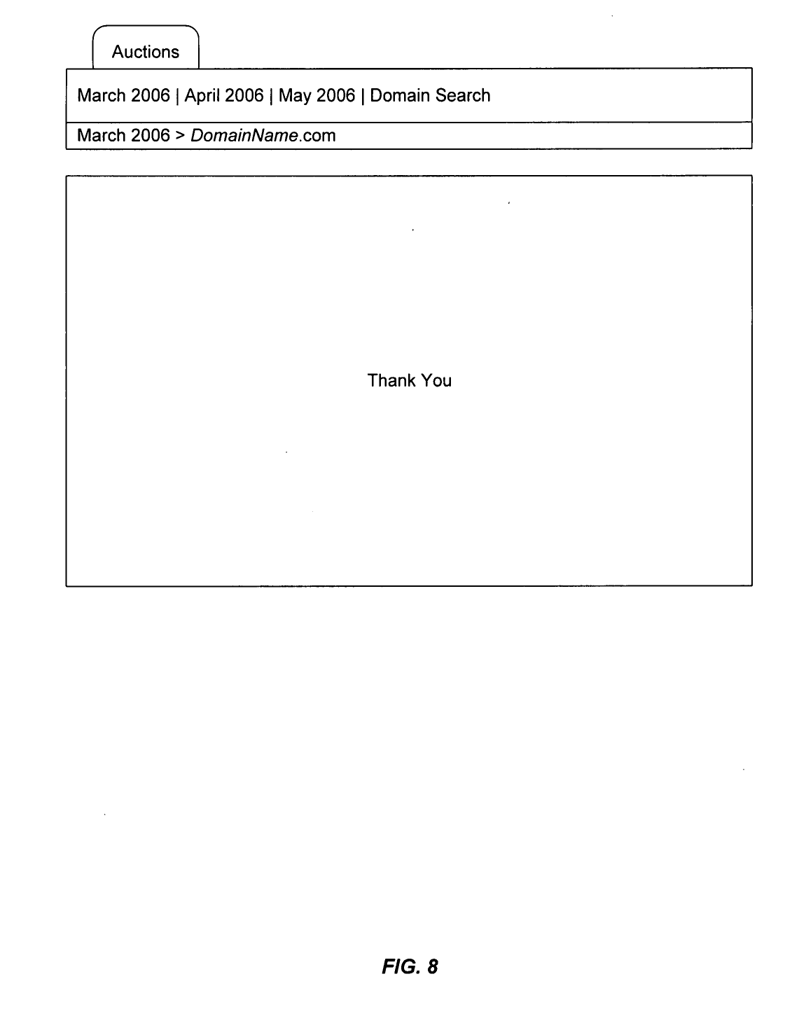

FIG. 8 illustrates the bidding completion screen of the application for facilitating a lease on a domain name through an online competitive bidding process according to the present invention. Once the bidder confirms its bid by clicking on the Confirm Bid button 730, the bid is received by the system of the present invention, and the bidding completion screen as shown in FIG. 8 is presented to indicate the completion of bidding.

A Method for Facilitating a Lease on a Domain Name Through an Online Competitive Bidding Process

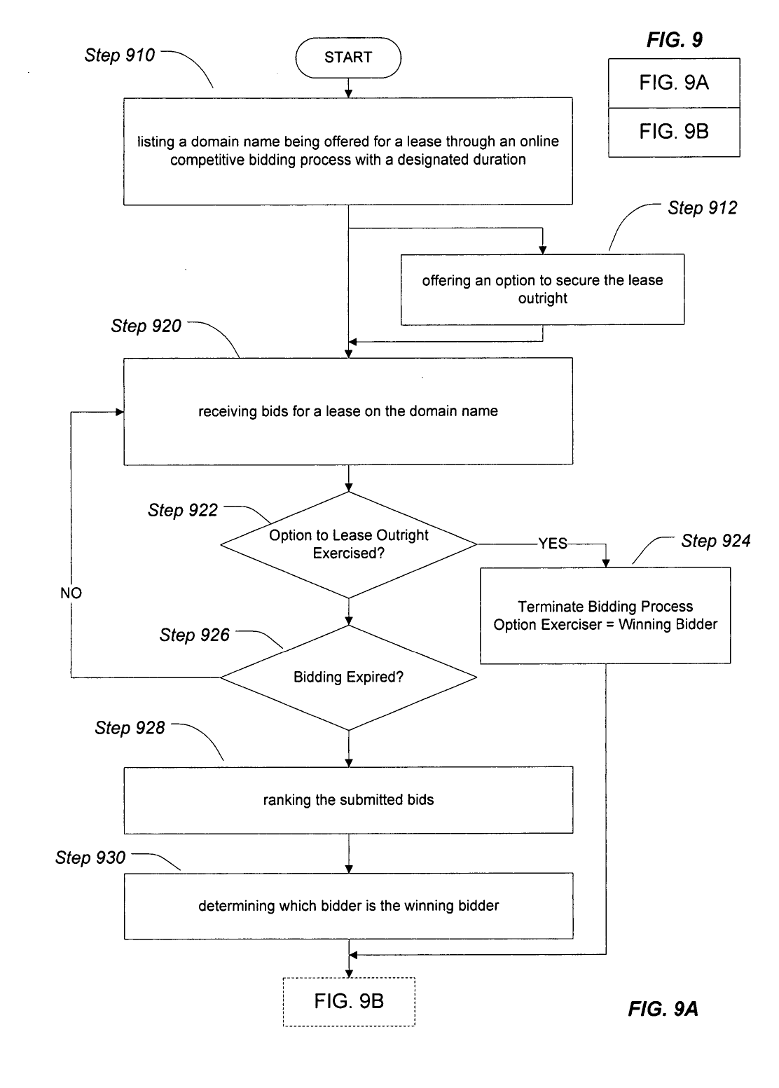

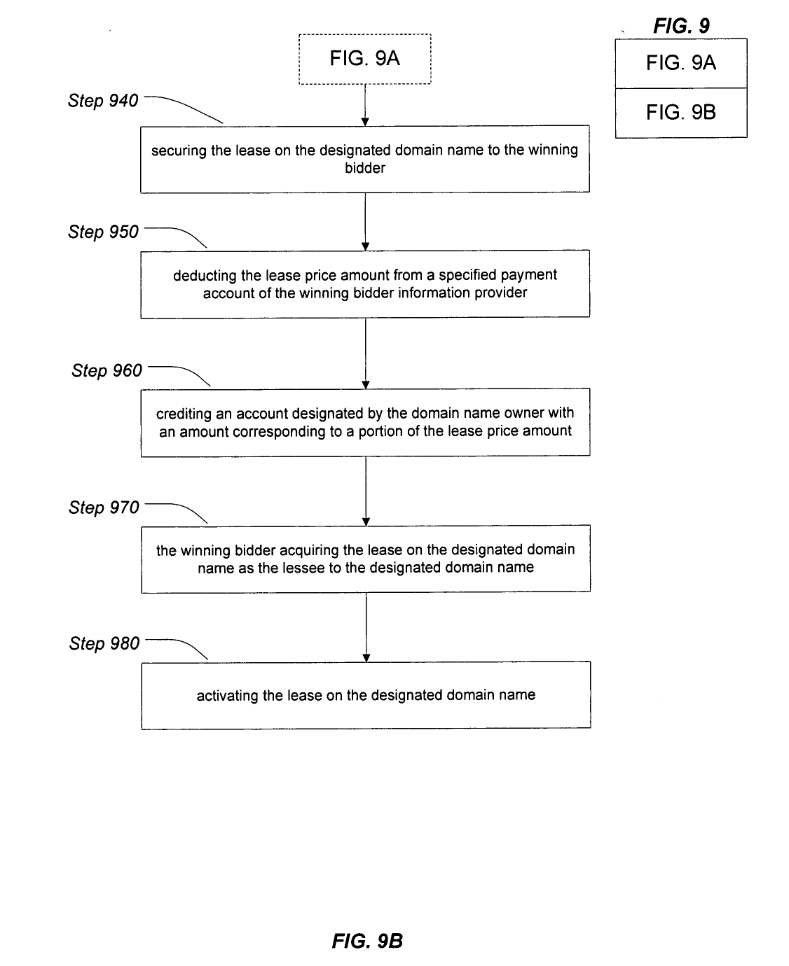

FIG. 9 illustrates a flowchart illustrating a method for facilitating a lease on a domain name through an online competitive bidding process according to the present invention. Before the bidding process can take place, a domain name owner establishes a domain name owner account 230 with the system of the present invention, and logs into the domain name owner account 230 using a computer network 130. Similarly, one or more bidders each establishes each own domain name lease account 220, and logs into each own domain name lease account 220 using the computer network 130. After logging in, the domain name owner then designates a domain name to be offered for lease, whereupon the domain name is listed for a lease in the Available Domain Names screen area 410, and the competitive bidding process starts with a fixed duration (Step 910). The system of the present invention can also offer an option to secure the lease outright by paying a designated “lease now” price (Step 912). As discussed above, the bidding screen includes the Place Bid button 520 and Lease It Now button 530. By clicking on the Lease It Now button 530, the bidder will proceed to a screen to confirm leasing the offered domain name outright at the “Lease It Now” price. When bidders submit bids for the lease by clicking on the Place Bid button 520, the bids are received (Step 920). The bids include at least the bid price which may be entered on the Bid Amount Entry screen area 610. In another embodiment, the bid can also include the length of the term of the lease as well as the bid price.

In addition, a bidder may exercise the option to lease the domain name outright by agreeing to pay a designated price (Step 922). If the option to lease outright has been exercised, then the bidding process is terminated and the option exercising bidder is designated as the winning bidder (Step 924). If the option is not exercised, then the bidding process continues until the designated bidding duration expires (Step 926).

At the expiration of bidding process duration, the submitted bids are ranked (Step 928), and the winning bidder is determined (Step 930). However, these steps are skipped if one of the bidders exercised the option to lease outright. In that case, the option exercising bidder is designated as the winning bidder as discussed above. Once the winning bidder has been determined, the lease on the designated domain name is secured to the winning bidder (Step 940).

Then the lease price amount is deducted from a specified payment account of the winning bidder (Step 950), and the account designated by the domain name owner is credited with an amount corresponding to a portion of the lease price amount (Step 960). Another portion of the lease price may be taken as a service fee without departing from the scope of the present invention. Upon completion of the financial transaction, the winning bidder acquires the lease on the domain name as the lessee to the domain name (Step 970), and the lease is activated for the lessee (Step 980).

In addition, when offering a lease on the designated domain name, a minimum bid amount may be designated. A bidder bidding for a domain name, on the other hand, can designate a maximum bid amount by entering the amount in the Maximum Bid Entry screen area 612. The bidder can also activate the automatic increment bidding process by checking the Auto Increment checkbox 620. The auto increment amount may be determined by the system of the present invention or specified by the bidder through the Increment Amount field 630.

According to the present invention, a lease to a domain name includes at least the facilitator directing visitors to the leased domain name to an Internet resource location of the lessee bidder's choice such as a Uniform Resource Locator (URL). In other words, the lease includes at least the right to use the Internet traffic to the leased domain name and direct the traffic to a web site or any other Internet resource or media location designated by the lessee. According to the present invention, however, a lease to a domain name can include more than the right to use the traffic. In a preferred embodiment, the lease to a domain name can include a right of the lessee such that the lease remains in effect during the term of the lease even if the ownership of the domain name is transferred to another party.

By enabling and facilitating lease on domain names through an online competitive bidding process, the present invention addresses the underlying problems of the current methods and models of domain name utilization and commerce as discussed above. The process enabled by the present invention provides a forum to publicize which domain names are available for lease while affording bidders multiple options that were previously nonexistent. As such, bidders are able to pick and choose which domain name(s) most closely embody their marketing concept without having to spend valuable time and resources inquiring about countless domain names. Furthermore, the competitive bidding process produces lease prices that closely approximate fair market values for both the domain name owners and bidders without costly negotiators.

In addition to bidders paying fair market value for their leases, the present invention allows bidders to make the decisions on what is the best means to promote their ends. Bidder lessees have the ability to utilize all of the possibilities an exclusive control of a domain name offers including utilization of subfolders, query strings, scripts, and application objects. In other words, having leased a domain name according to the present invention, the bidder lessee can host a full range of Internet applications including complex Web applications at the leased premium domain name. For example, a bidder lessee has the ability to sell to consumers directly on the website at the leased premium domain name, allow users to post responses, and receive emails at the website. At the same time, the bidder lessee can enjoy the same advantage of having exclusive control over the domain name at a much lower cost than the price of owning the premium domain name outright.

The present invention provides beneficial advantages to premium domain name owners as well, for the present invention allows premium domain name owner investors a just and reasonable return on their investments in a more efficient way. Under prior systems and methods, premium domain name owner investors were unable to recognize the true earning potential of their domain names through hosting segmental advertising. Similar to a multi-million dollar home generating only a couple of thousands of dollars of income per month, premium domain owner investors often only generated a couple of thousands of dollars per month on a multi-million dollar domain name. Previously, domain name owner investors could only realize a fair return on their investment when they found a willing buyer of their domain name. However, a sale of a premium domain name was rare. Ironically, the value of a premium domain name was out of reach of most recently created entities while established entities who could afford to buy such domain names already had legally protected rights in their well-known service mark domain names and did not need to purchase premium domain names from a third party. The present invention addresses this irony by providing premium domain name owner investors with a forum of bidders who compete to obtain a lease on a domain name. As this lease is on the entire utility of a premium domain name and acquired through competition among bidders, domain name owner investors can be assured a fair and adequate return on the entirety of their domain name investment. At the same time, the domain name owners will have access to a much larger market for their valuable asset and be able to generate steady income much more efficiently.

For the bidders who wish to own the domain name outright, the present invention also offers a “Lease To Own” option. According to the present invention, a domain name owner is able to offer to a leasing bidder an exclusive option for a designated period of time to purchase the leased domain name. The domain name owner designates the price at which an option may be purchased, as well as the exercise price of said option. Once a bidder has secured a lease on a domain name, the present invention can, at the sole discretion of the domain name owner, present the bidder with an option to purchase the leased domain name at a specified exercise price, exercisable by the bidder only during the lease term. If the bidder elects to purchase the option, the facilitator will deduct the option purchase price from a specified payment account of the leasing bidder. The facilitator will then credit an account designated by the domain name owner with an amount corresponding to a portion of the option purchase price. If the bidder subsequently elects to exercise the option and purchase the domain name from the domain name owner, the facilitator will then facilitate the transaction, including but not limited to facilitating the transfer of the domain name and the transfer of funds representing a portion of the domain name purchase price.

The Marketing Campaign Enabled by The System and Method Of The Present Invention

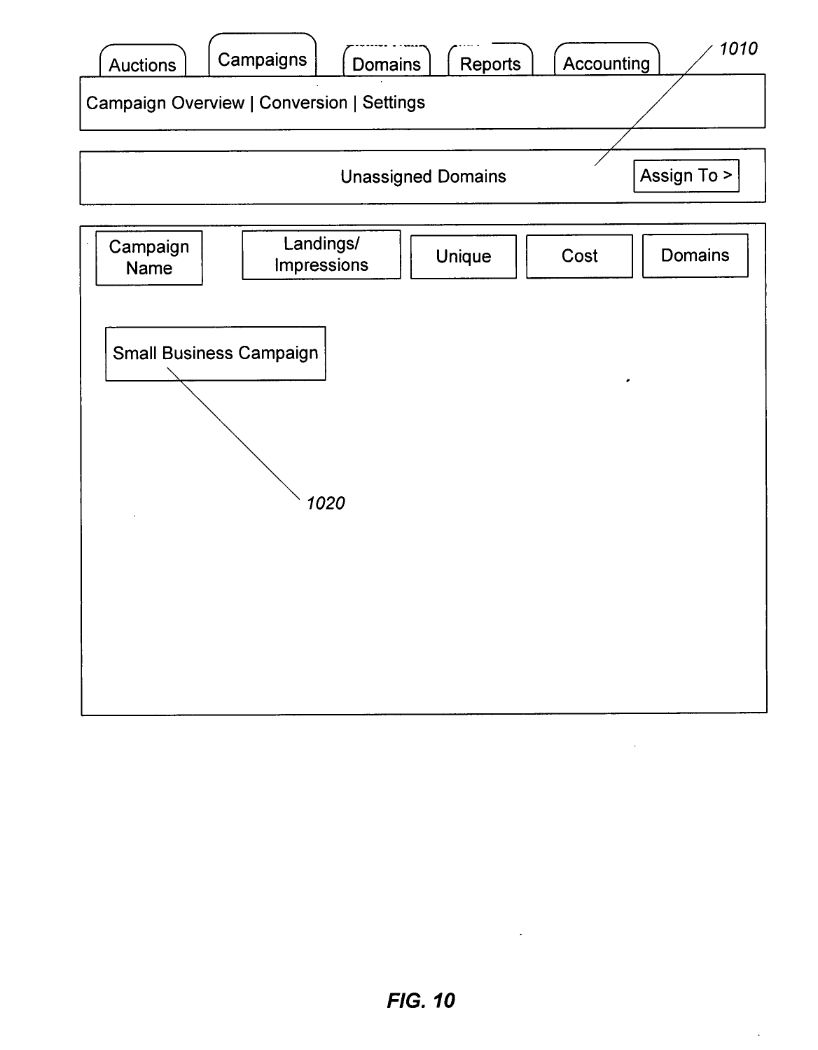

FIG. 10 illustrates the campaign screen of the application for facilitating a lease on a domain name through an online competitive bidding process according to the present invention. As shown in FIG. 10, leased domain names are displayed in the Unassigned Domains area 1010 which is updated in substantially real time as bidders acquire leases on offered domain names. Bidders may create various campaigns, such as the one shown in screen area 1020, and designate domain names under each campaign. This serves to facilitate bidders' management of leased domain names who have a multitude of objectives in leasing domain names. For example, an advertisement agency who handles various clients may designate a campaign for each client to conveniently ascertain the effectiveness of the leasing program on a client by client basis. As shown in FIG. 10, bidders receive per campaign data on the amount of landings/impressions, unique IP landings, the accumulative amount to secure leases on domain names designated to the campaign, and the domain names designated to the campaigns.

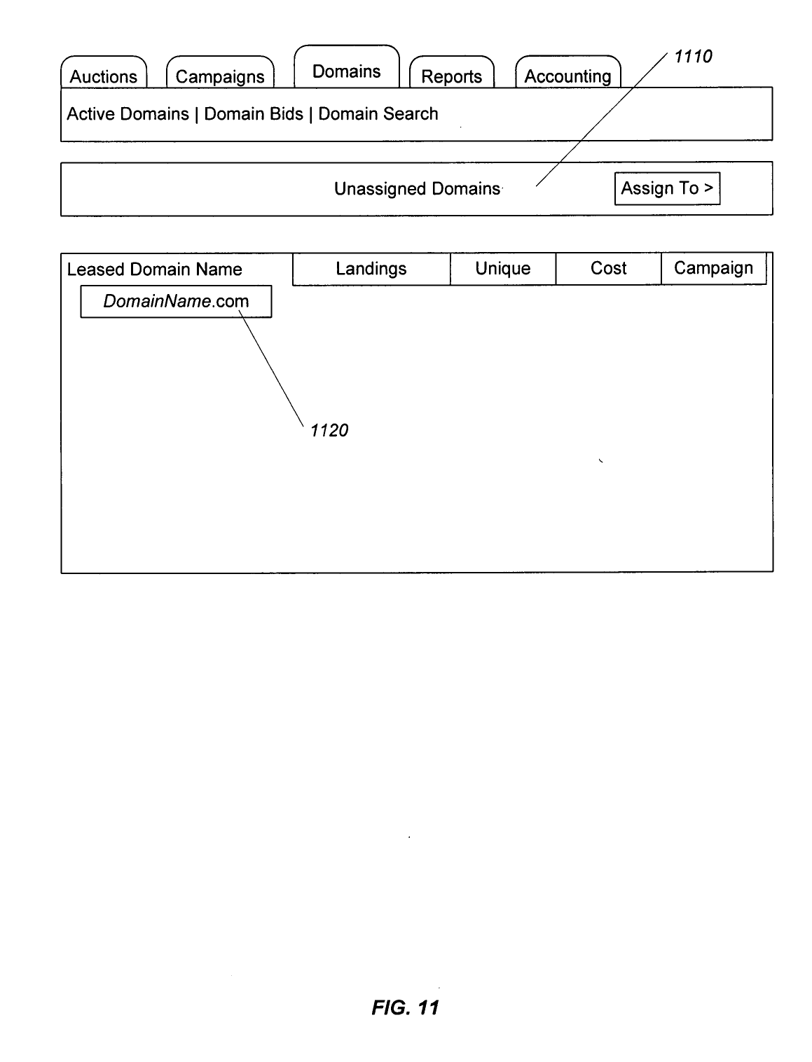

FIG. 11 illustrates the leased domain name screen of the application for facilitating a lease on a domain name through an online competitive bidding process according to the present invention. As shown in FIG. 11, leased domain names are displayed in the Unassigned Domains area 1110 which is updated in substantially real time as bidders acquire leases on offered domain names. Leased domain names will appear in areas 1110 and 1010 until each domain name is assigned to a campaign. As shown in FIG. 11, bidders receive per domain name data on the amount of landings, unique IP landings, the cost to acquire a lease on the domain name, and the campaign designation of each domain. To receive such data, leased domain names must be designated to a campaign.

While the present invention has been particularly described with reference to the various figures and embodiments, it should be understood that these are for illustration purposes only and should not be taken as limiting the scope of the invention. There may be many other ways to implement the invention. Many changes and modifications may be made to the invention, by one having ordinary skill in the art, without departing from the spirit and scope of the invention.

What is claimed is:

1. A method for facilitating a lease on a domain name using a computer network through an online competitive bidding process, the method comprising:
listing a domain name being offered for a lease;
receiving bids for a lease on the domain name through an online competitive bidding process with a designated duration, wherein the bids include at least the bid price;
ranking the received bids, wherein the ranking is based on at least the bid price; and
determining the winning bid with the highest ranking at the expiration of the designated duration of the bidding process.

2. The method of claim 1, further comprising:
assigning the lease to the domain name to the bidder of the winning bid as a lessee.

3. The method of claim 2, wherein the lease on the domain name includes at least directing visitors to the leased domain name to an Internet resource location of the lessee's choice such as a Uniform Resource Locator (URL).

4. The method of claim 3, wherein the lease on the domain name includes a right of the lessee such that the lease remains in effect during the term of the lease even if the ownership of the domain name is transferred to another party.

5. The method of claim 1, wherein the bids include a length of the lease term, and the ranking of the bids is based on at least the bid price and the bid lease term.

6. The method of claim 1, further comprising:
designating a minimum bid amount when listing a domain name being offered for a lease.

7. The method of claim 1, further comprising:
offering an option to secure the lease outright by electing to pay an option price, and, when the option is first exercised, terminating the bidding process and securing the lease to the bidder who exercised the option.

8. The method of claim 1, further comprising:
accepting a maximum bid amount from a bidder when receiving bids for a lease on the domain name.

9. The method of claim 8, further comprising:
accepting and activating an automatic bidding process where a successively higher bid is placed automatically on behalf of the bidder who entered the maximum bid amount against outranking bids by competing bidders in pre-determined increments up to the maximum bid amount.

10. The method of claim 1, further comprising:
offering the lessee an option to purchase the leased domain name, the option being exercisable by the lessee during the lease term.

11. The method of claim 10, further comprising:
facilitating transfer of the leased domain name from the domain name owner to the lessee when the lessee purchases the option to purchase the leased domain name and exercises the option to purchase the domain name during the lease term.

12. A system for facilitating a lease on a domain name using a computer network through an online competitive bidding process, the system comprising:
a computer system;
programming code on the computer system for offering a domain name for lease through an online competitive bidding process in substantially real time;
programming code on the computer system for allowing one or more bidders to enter bids for leasing the domain name and participate in the online competitive bidding process with a designated duration in substantially real time, wherein the bids include at least the bid price;
programming code on the computer system for ranking the bids, wherein the ranking is based on at least the bid price; and
programming code on the computer system for determining which bidder is the winning bidder at the expiration of the designated duration of the bidding process.

13. The system of claim 12, further comprising:
programming code on the computer system for assigning the lease to the domain name to the winning bidder as a lessee.

14. The system of claim 13, further comprising:
programming code on the computer system for directing visitors to the leased domain name to an Internet resource location of the lessee's choice such as a Uniform Resource Locator (URL).

15. The system of claim 12, further comprising:
a database stored on the computer system, the database comprising:
at least one account record for a domain name owner including a unique account identifier for the domain name owner and at least one domain name designated for lease; and
at least one account record for each of one or more bidders including a unique account identifier and an acquired lease field for each of the one or more bidders;
programming code on the computer system for providing the domain name owner with login access which grants the domain name owner access to modify the domain name owner's account record; and
programming code on the computer system for providing each of the one or more bidders with login access which grants each of the one or more bidder access to modify its own account record.

16. The system of claim 12, wherein the bids include a length of the lease term, and the ranking of the bids is based on at least the bid price and the bid lease term.

17. The system of claim 12, further comprising:
programming code on the computer system for designating a minimum bid amount.

18. The system of claim 12, further comprising:
programming code on the computer system for offering an option to secure the lease outright by electing to pay an designated option price, and, when the option is first exercised, terminating the bidding process and designating the option exercising bidder as the winning bidder and the option price as the winning price, thereby securing the lease to the option exercising bidder at the option price.

19. The system of claim 12, further comprising:
programming code on the computer system for allowing each of the one or more bidders to enter a maximum bid when entering bids for leasing the designated domain name.

20. The system of claim 19, further comprising:
programming code on the computer system for allowing the bidder who has entered a maximum bid to activate an automatic bidding process where a successively higher bid is placed automatically on behalf of the automatic bidding process activating bidder against outranking bids by competing bidders in pre-determined increments up to the maximum bid.

21. The system of claim 12, further comprising:
programming code on said computer system for adding a modifiable campaign; and
programming code on said computer system for deleting a modifiable campaign;
wherein the database further comprises at least one campaign record.

22. Computer-executable process steps for facilitating a lease on a domain name using a computer network through an online competitive bidding process, the steps comprising:
a step for listing a domain name being offered for a lease;
a step for receiving bids for a lease on the domain name through an online competitive bidding process with a designated duration, wherein the bids include at least the bid price;
a step for ranking the received bids, wherein the ranking is based on at least the bid price;
a step for determining the winning bid with the highest ranking at the expiration of the designated duration of the bidding process;
a step for securing the lease on the domain name to the bidder of the winning bid with the winning bid amount as the lease price;
a step for conveying the lease on the domain name to the bidder of the winning bid as the lessee to the domain name;
a step for activating the lease on the domain name for the lessee; and
a step for directing visitors to the leased domain name to an Internet resource location of the lessee's choice such as a Uniform Resource Locator (URL).
